(19) United States
(12) Patent Application Publication
(10) Pub. No.: US 2025/0121401 A1
(43) Pub. Date: Apr. 17, 2025

(54) Vision System for Sealant Accuracy

(71) Applicant: FANUC America Corporation, Rochester Hills, MI (US)

(72) Inventor: David W. Lazar, Troy, MI (US)

(21) Appl. No.: 18/910,092

(22) Filed: Oct. 9, 2024

Related U.S. Application Data
(60) Provisional application No. 63/589,730, filed on Oct. 12, 2023.

(51) Int. Cl. B05C 11/02; B05C 5/02; B05C 21/00; B25J 9/16; B25J 15/00

(52) U.S. Cl. CPC B05C 11/023; B05C 5/0208; B05C 21/00; B25J 9/1697; B25J 15/0019

(57) ABSTRACT

A vehicle assembly system for sealing and skiving vehicle seams. The assembly system includes an upstream seam sealant station that determines offsets between vehicle reference points and the seams using a vision sensors and sends the offsets to a downstream seam skiving station. The assembly system also measures the size of the sealant bead and controls the sealant dispense pressure to maintain the desired size.

### CROSS-REFERENCE TO RELATED APPLICATIONS

This application claims the benefit of the filing date of U.S. Provisional Application No. 63/589,730, titled, Robotic Sealer Dispense and Skive Applicator and Process, filed Oct. 12, 2023.

### BACKGROUND

### Field

This disclosure relates generally to a vehicle assembly system for sealing and skiving vehicle seams and, more particularly, to a vehicle assembly system for sealing and skiving vehicle seams, where the assembly system includes an upstream seam sealant station that determines offsets between vehicle reference points and the seams using vision sensors and sends the offsets to a downstream seam skiving station.

### Discussion of the Related Art

Various assemblies require seals. One of those assemblies is vehicles. For example, vehicles often require seals around certain vehicle parts, such as windshields, rear windows, light covers, etc., to prevent moisture and fume intrusion into the vehicle passenger compartment. Current vehicle paint shop sealing processes typically require manual operators to lay down a viscous sealant, such as a liquid polyvinyl chloride (PVC) sealant. The current process requires the manual operator to wipe (skive or squeegee) sealant off the seam and leave a small amount of sealer in the seam, which is a very labor-intensive process and wasteful of the excess sealant, thus costly. This is required for a part fit up on the sealed vehicle body.

During the vehicle manufacturing process, gauge holes provided in the floor pan or subframe of the vehicle are used as a key point of reference to build the vehicle body structure. The sub-assemblies and panels of the vehicle are assembled using the gauge holes as a base line. As the vehicle is being assembled, key body features important to the appearance of the vehicle must be maintained. In order to accomplish the dimensional requirement of the body exterior, seams of the body panels are used to adjust the key body features. This creates seam drift, where the seams constantly move dimensionally to compensate for the key body features. The seams of the vehicle require small beads of sealant to meet the process requirements. Known systems employ vison sensors to measure the seam drift for the process or fixed sensors. This vision process is very time consuming.

The PVC sealant is manufactured in large batch mixers, which creates batch to batch viscosity variations. Additionally, the PVC sealant is pre-catalyzed, and thus it is very sensitive to aging, which also affects the viscosity of the material. This variation in viscosity creates a variation in the application of the sealant onto the seams, which causes variations in the bead seam widths of the sealant applied to the seams. A too narrow sealant bead can cause a water leak into the vehicle causing a warranty claim. A too wide sealant bead can cause an assembly fit up issue where a sub-assembly cannot be assembled onto the vehicle without removing the large bead of the sealant from the interference point causing a need to manually repair the production vehicle. The current correct action for the end user is to manually adjust the pre-pressure of each bead/seam to compensate for the change in material viscosity. This manual adjustment procedure is very time consuming.

Modern vehicle assemblies employ robots to perform a variety of tasks, such as vehicle body welding and painting. The tasks being performed by vehicle assembly robots are becoming more complex and intricate. The dispensing of sealants into intricate vehicle locations is one of those areas where robots are becoming more useful. However, the seams in certain areas of the vehicle, for example, in the tail lamp area, are dimensionally unstable, which makes robotic application of a sealant more difficult.

### SUMMARY

The following discussion discloses and describes a vehicle assembly system for applying a sealant to seams on a vehicle, where the vehicle includes gauge reference holes. The assembly system includes a first assembly station having at least one vision sensor and at least one robot having a vision sensor and a dispense applicator, where the dispense applicator is configured to apply the sealant to the seams. The at least one vision sensor at the first assembly station provides images of the gauge reference holes on the vehicle, and the vision sensor on the at least one robot at the first assembly station provides images of the seams on the vehicle. The assembly system further includes a second assembly station positioned downstream from the first assembly station and having at least one vision sensor and at least one robot with a vision sensor and a skive, where the skive is configured to remove excess sealant from the seams on the vehicle. The at least one vision sensor at the second assembly station provides images of the gauge reference holes on the vehicle. The assembly system also includes a control system responsive to signals from the vision sensors. The control system uses the signals from the at least one vision sensor at both the first assembly station and the second assembly station to identify the orientation and location of the vehicle in space and uses the signals from the vision sensor on the at least one robot at the first assembly station to provide an offset of the seams relative to the gauge reference holes on the vehicle. The control system provides the offsets from the first assembly station to the second assembly station so that the second assembly station knows the location of the seams relative the gauge reference holes determined at the first assembly station. The control system also uses the signals from the vision sensor on the at least one robot at the first assembly station to measure a size of the sealant that has been dispensed by the dispense applicator, and controls a dispensing pressure of the dispense applicator so as to maintain a certain size of the sealant.

Additional features of the disclosure will become apparent from the following description and appended claims, taken in conjunction with the accompanying drawings.

### BRIEF DESCRIPTION OF THE DRAWINGS

FIG. 1 is an illustration of an assembly line for applying a sealant to vehicles;

FIG. 2 is a cut-away isometric view of a robot including a precision sealing applicator attached to a robot arm;

FIG. 3 is an illustration of a manufacturing system showing a robot having a skive tool assembly with a sealant dispensing nozzle and a vehicle part receiving the sealant;

FIG. 4 is a cut-away isometric view of the skive assembly shown in FIG. 3 with one of the skives extended;

FIG. 5 is a cut-away, isometric view of a sealant dispensing and skiving applicator for a robot to apply and skive a sealant simultaneously;

FIG. 6 is an isometric view of a skive cleaner;

FIG. 7 is a front view of the skive cleaner shown in FIG. 6 showing an internal filter and waste collection container; and

FIG. 8 is an isometric view of a skive solvent wash cleaner.

### DETAILED DESCRIPTION OF THE EMBODIMENTS

The following discussion of the embodiments of the disclosure directed to a vehicle assembly system for sealing and skiving vehicle seams, where the assembly system includes an upstream seam sealant station that determines offsets between vehicle reference points and the seams using vision sensors and sends the offsets to a downstream seam skiving station is merely exemplary in nature, and is in no way intended to limit the disclosure or its applications or uses.

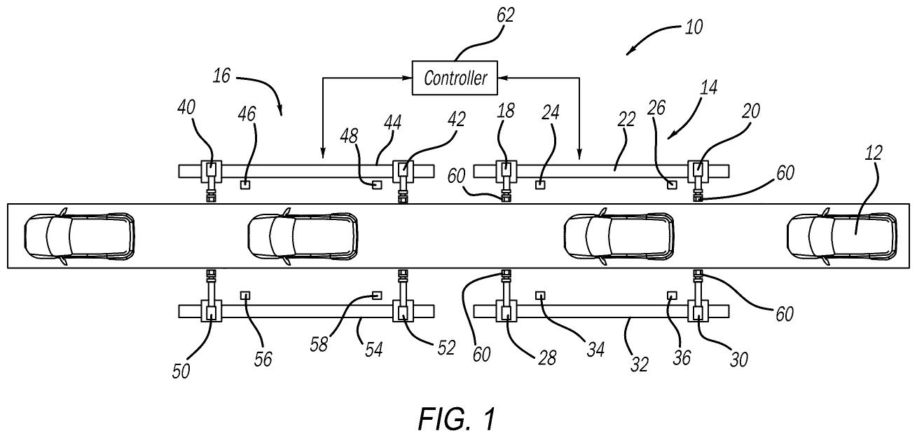

FIG. 1 is an illustration of an assembly line 10 for applying a sealant to vehicles 12 that move along the line 10. The assembly line 10 includes a stop station 14 where a sealant is dispensed into seams on the vehicle 12 that is currently stopped at the station 14. The assembly line 10 also includes a stop station 16 where excess sealant is removed from the seams on the vehicle 12 that is currently stopped at the station 16. In an alternate embodiment, the stop station 14 and/or the stop station 16 can provide both sealant dispensing and skiving as will become apparent from the discussion below.

The stop station 14 includes two robots 18 and 20 slidable on a rail 22 and two vision sensors 24 and 26 positioned at one side of the vehicle 12 and two robots 28 and 30 slidable on a rail 32 and two vision sensors 34 and 36 positioned at the other side of the vehicle 12. Likewise, the stop station 16 includes two robots 40 and 42 slidable on a rail 44 and two vision sensors 46 and 48 positioned at one side of the vehicle 12 and two robots 50 and 52 slidable on a rail 54 and two vision sensors 56 and 58 positioned at the other side of the vehicle 12. The number of robots at the stop stations 14 and 16 are shown by example in that any reasonable number of robots can be employed for a particular operation. Each of the robots 18, 20, 28 and 30 includes a robot mounted vision sensor 60 that locates individual seams on the vehicle 12. A vision controller 62 represents all of the vision control devices necessary to control the vision sensors 60 on the robots 18, 20, 28, 30, 40, 42, 50 and 52, and the vision sensors 24, 26, 34, 36, 46, 48, 56 and 58 consistent with the discussion herein, where multiple controllers and devices would be required.

The vehicles 12 are equipped with gauge holes (not shown) on each quadrant on the body of the vehicle 12 that provide reference locations on the vehicle 12. The gauge holes are imaged by the vision sensors 24, 26, 34 and 36, and the vision controller 62 uses those images to identify the orientation and location of the vehicle 12 in space. Once the gauge holes are imaged and the location of the vehicle 12 is mathematically identified by the vision controller 62 when stopped at the stop station 14, the vision sensors 60 on the robots 18, 20, 28 and 30 provide images to the vision controller 62 that identifies the location or offset of the seams on the vehicle 12 relative to the gauge holes to which the robots 18, 20, 28 and 30 are going to apply the sealant. Particularly, the vision sensors 60 on the robots 18, 20, 28 and 30 provide seam drift location measurements and variations. The robot path is modified for the seam drift variations and the robots 18, 20, 28 and 30 apply a sealant using a suitable sealant applicator to the various seams on the vehicle 12 stopped at the station 14. As will be discussed below, the seam drift offsets from the station 14 are sent to the station 16 to be used by the robots 40, 42, 50 and 52 to perform a skiving operation to remove excess sealant on the vehicle 12 stopped at the station 16.

Traditionally, this process of identifying the offset of the seams, or some other feature on the vehicle 12, was performed at each stop station 14 and 16. This disclosure proposes determining the mathematical offsets between the seams and the gauge holes, or other features, at a first stop station, here the stop station 14, and transfer or send those offsets to downstream stop stations, such as the stop station 16, so that the offsets at the downstream stop stations do not need to be recalculated, which reduces cycle time. Further, if the offsets do not need to be recalculated at the downstream stop stations, then the robots at those stop stations may not need the vision sensors 60, which reduces hardware. The vision systems at those downstream stop stations would still need to identify the location of the gauge holes on the vehicle 12. Once the location of the gauge holes are identified, then the offsets that have been received from an upstream stop station are used to identify the location of the seams. In other embodiments, it may be desirable to have a first stop station that only determines the offsets between the gauge holes and the features on the vehicle that are then sent to downstream stop stations.

Typically, a positive displacement metering system is used to maintain a constant flow rate of sealant to the sealant applicator on the robot. As generally discussed above, as the viscosity of the material changes, the amount of pre-pressure used at the start of dispensing the sealant bead is constant and causes the start of the bead to change as the viscosity of the sealant changes. As the material viscosity decreases, the bead size will initially increase on the initial opening of the sealant applicator, which creates a larger bead than desired. As the material viscosity increases on the initial opening of the sealant applicator, a smaller sealant bead is created than desired.

This disclosure proposes using a vision system and control algorithm, for example, the vision sensors 24, 26, 34 and 36, the vision sensors 60, the vision controller 62 and the sealant dispense controller, to adjust the dispense system pre-pressure of the sealant applicator on, for example, the robots 18, 20, 28 and 30 to compensate for viscosity changes in the sealant as it is being dispensed. The vision system measures a key area of the seam, typically the start of the bead width on each vehicle 12. The vision controller 62 provides the bead width data back to the sealant dispense controller associated with each robot 18, 20, 28 and 30. The vision system also measures multiple points on the seam to provide individual seam width data and very accurate sheet metal seam location, such as less than 0.5 mm seam location accuracy. With the control algorithm, the dispense controller adjusts the pre-pressure up or down to compensate for the changing viscosity of the sealant.

This disclosure also proposes a robot sealant applicator that includes robotic vision and precision applicator tips to precisely place the sealant on the seam to eliminate or reduce the labor-intensive manual skiving process. In one embodiment, a small 3 mm to 12 mm bead width of sealant is dispensed onto the seam in the precise location to eliminate or reduce the need for manual or robotic skiving. The precision sealer applicator is designed to fit into tight areas such as tail lamp areas of the vehicle.

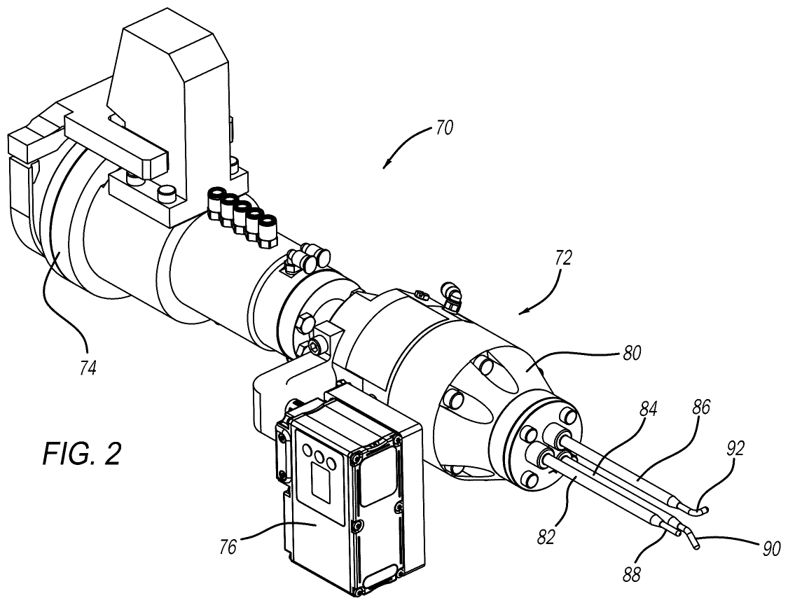

FIG. 2 is a cut-away isometric view of a precision robot end or arm tool 70 including a precision sealant applicator 72 and a material/air line swivel 74 that is applicable for the purposes discussed herein. The applicator 72 includes an optional camera 76 attached to the swivel 74 and an applicator body 80 having three nozzles 82, 84 and 86 extending therefrom, and being oriented 120° relative to each other. The nozzle 82 includes a straight nozzle tip 88 oriented at 0°, the nozzle 84 includes a curved nozzle tip 90 oriented at 45°, and the nozzle 86 includes a curved nozzle tip 92 oriented at 90°. The nozzles 82, 84 and 86 thus provide a compact design with optimized angles to accurately dispense sealant into tight or intricate locations with minimal waste, for example, with sealant bead widths in the 2 mm-8 mm range. In other designs, a different number of nozzles may be provided.

This disclosure also includes a discussion of a robotic process where a robot or robots utilize a precision tool to both dispense a sealant onto and skive the sealant off of a seam or seams of a vehicle. The robot applicator includes a precision applicator tip or tips to precisely place the sealant on the seam to facilitate robotic skiving, thus eliminating the labor-intensive manual skiving process. A small bead of sealant is dispensed onto the seam in the precise location, and then a skive or skives located on the tool skive off excess material to leave a very flat sealed seam, where parts such as window glass, or other sub-assemblies, can be assembled over the sealed joint and not to interfere with the glass to body seal.

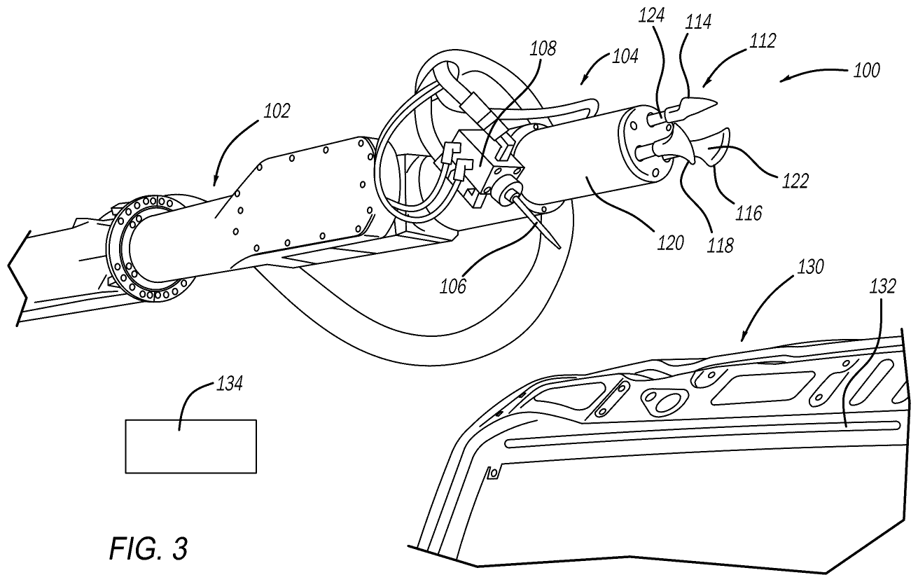

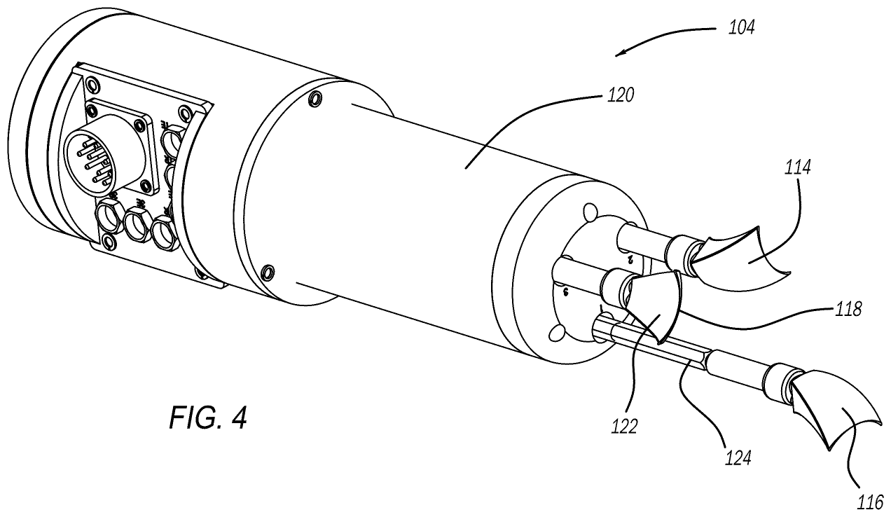

FIG. 3 is a cut-away, isometric view of a manufacturing system 100 including a robot arm 102 having an end-effector 104 coupled thereto illustrating such a design. The end-effector 104 includes a nozzle 106 from which a viscous sealant is dispensed, such as liquid PVC. The nozzle 106 is attached to various equipment 108 including sealant dispense controller that controls the nozzle 106 to dispense the sealant. The end-effector 104 also includes a skive assembly 112 having three skives 114, 116 and 118 rigidly attached to and extending from a coupler 120 on a rod 124, where the skives 114, 116 and 118 are positioned in a circle and spaced 120° relative to each other. FIG. 4 is a cut-away isometric view of the end-effector 104 with the nozzle 106 and equipment 108 removed. In one non-limiting embodiment, the skives 114, 116 and 118 are triangular shaped paddles made of a rubber compound. The skives 114, 116 and 118 are formed to have a cup portion 122 that allows the skives 114, 116 and 118 to hold a certain amount of sealant during the skiving operation. During the skiving operation, one of the skives 114, 116 or 118 is extended on the rod 124, and that skive 114, 116 or 118 is used to remove excess sealant. The skives 114, 116 and 118 and the rods 124 are keyed to maintain skive position when the skive is changed. FIG. 4 shows the skive 116 being extended. When the cup portion 122 of that skive 114, 116 or 118 is full, the skive 114, 116 or 118 is retracted, the coupler 120 is rotated and another skive 114, 116 or 118 is extended to continue with the skiving operation. When the cup portion 122 of all of the skives 114, 116 and 118 are full of sealant, the sealant is removed from the cup portion 122 and the skives 114, 116 and 118 are cleaned, as will be discussed in detail below.

In this example, the manufacturing assembly 100 includes a vehicle part 130, specifically a rear window frame of a truck, that receives the sealant. The robot arm 102 is controlled so that the nozzle 106 is positioned at the proper location near the part 130. The robot arm 102 moves the nozzle 106 along the part 130 so that as the sealant is being dispensed from the nozzle 106 the sealant is deposited as a sealant bead 132 on the part 130. Once the sealant bead 132 is deposited on the part 130, the robot arm 102 is controlled to place one of the skives 114, 116 or 118 on the sealant and move the selected skive 114, 116 or 118 along the bead 132 to remove excess sealant. The part 130 is then placed in an oven 134 to heat and cure the sealant to provide the desired seal.

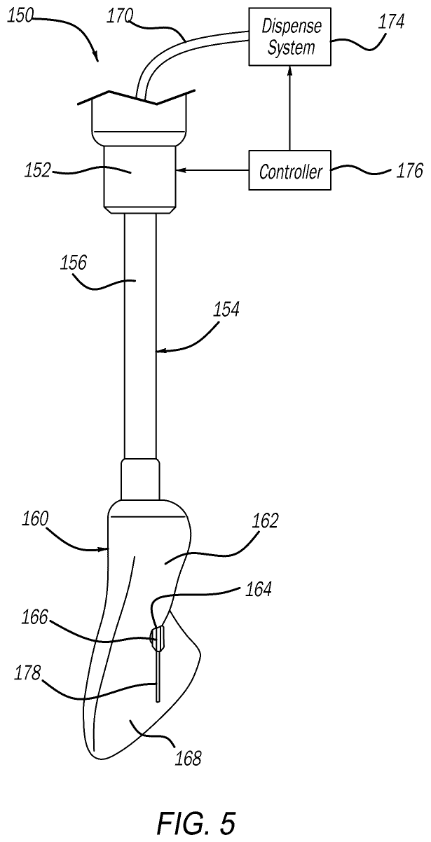

FIG. 5 is a cut-away isometric view of a robotic sealant system 150 including an end-effector 152 that may be configured to be attached to the robot arm 102 instead of the end-effector 104 in an alternate embodiment. The system 150 includes a sealant tool 154 having a hollow rod 156 secured to the end-effector 152 at one end. The tool 154 also includes a skive 160 attached to the rod 156 opposite to the end-effector 152. The skive 160 has a similar shape, size and material as the skives 114, 116 and 118, but also includes a hollow upper portion 162 having an opening 164. A nozzle 166 is secured in the opening 164 and faces downward towards a lower end 168 of the skive 160. An applicator 170 is attached to the nozzle 166 inside of the hollow portion 162 and is threaded up through the rod 156 and attached to a dispense system 174 that includes a source of the sealant. The system 174 also includes a valve through which the sealant is dispensed and a metering device that selectively causes the proper amount of sealant to be dispensed. In one embodiment, the dispense system 174 controls the valve to emit sealant in a pulsed manner using, for example, pulse width modulation (PWM), so that the nozzle 166 does not continuously deposit the sealant, but deposits the sealant as dots of sealant in a pulsed manner, which saves sealant material. A controller 176 represents all of the control devices necessary for controlling the position of the tool 154 and operation of the dispense system 174.

The tool 154 is positioned, for example, relative to the part 130 so that the nozzle 166 is at the proper location to place the bead 132 of sealant. The controller 176 controls the dispense system 174 to pump sealant down the applicator 170 to be dispensed by the nozzle 166 as a continuous sealant stream 178 or in a pulsed manner. The controller 176 moves the tool 154 so that the nozzle 166 dispenses the sealant stream 178 to form the bead 132 and at the same time the skive 160 removes excess sealant as it is being laid down on the part 130.

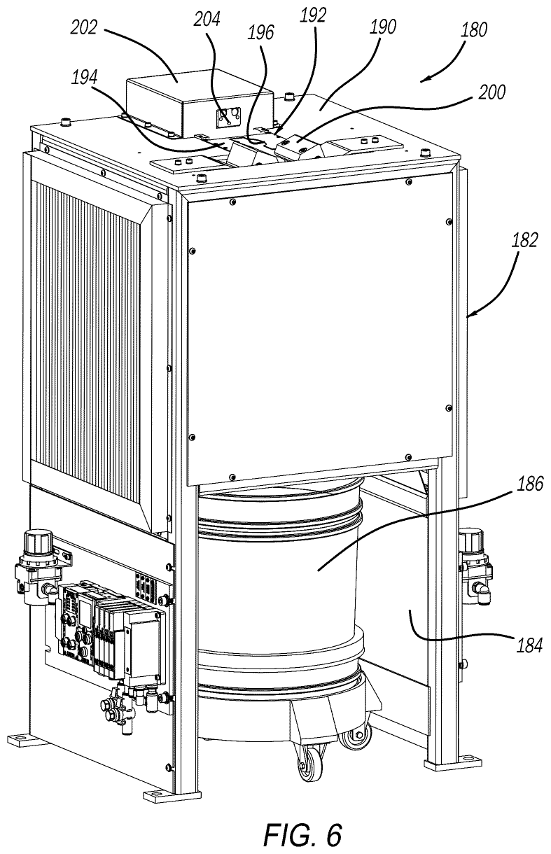

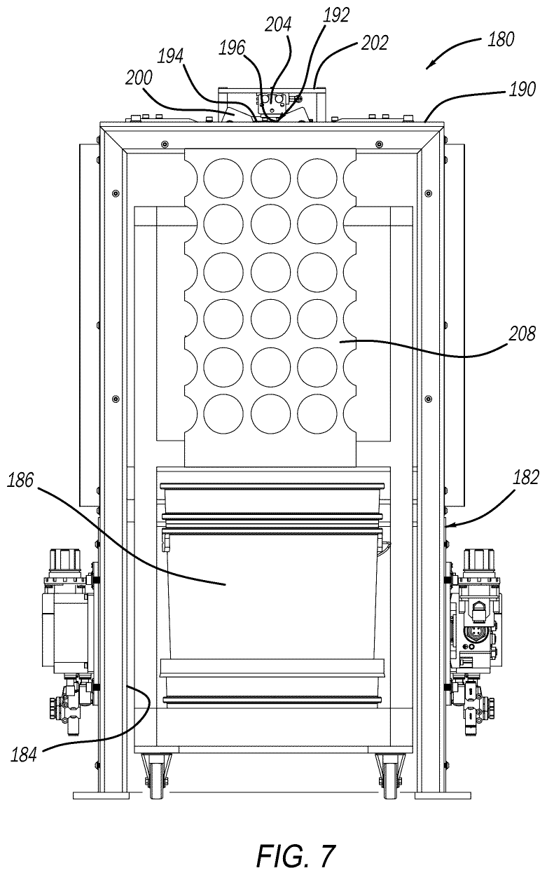

As mentioned above, the skives 114, 116 and 118 need to be periodically cleaned to remove the collected sealant therefrom. FIG. 6 is an isometric view and FIG. 7 is a front view of a skive cleaner 180 for removing the sealant from the skives 114, 116 and 118. The skive cleaner 180 can also clean the skive 160. The cleaner 180 includes a rectangular frame 182 having an open bottom portion 184 that allows a collection bucket 186 to be positioned within the frame 182. The cleaner 180 also includes a top plate 190 that supports a skive front/back wiping structure 192 having a frame 194 and an opening 196 shaped to accept the skives 114, 116 and 118. When the cup portion 122 of each of the skives 114, 116 or 118 is full, the robot arm 102, in this example, moves the skive assembly 112 to the skive cleaner 180. One of the skives 114, 116 or 118 is extended and inserted into the opening 196 in a manner that causes the sealant in the cup portion 122 to be scraped off on the edges of the opening 196. That extended skive 114, 116 or 118 is then placed in an air wiping device 200 that blows air onto the extended skive 114, 116 or 118 to remove any remaining sealant on the extended skive 114, 116 or 118. At the same that the air wiping device 200 blows air onto the extended skive 114, 116 or 118, an actuator 202 extends a cleaning arm 204 into the structure 192 that pushes the collected sealant in the frame 194 into the bucket 186. The skive 114, 116 or 118 is then retracted and the other skives 114, 116 or 118 are cleaned in the same manner. A media filter 208 is attached to the frame 182.

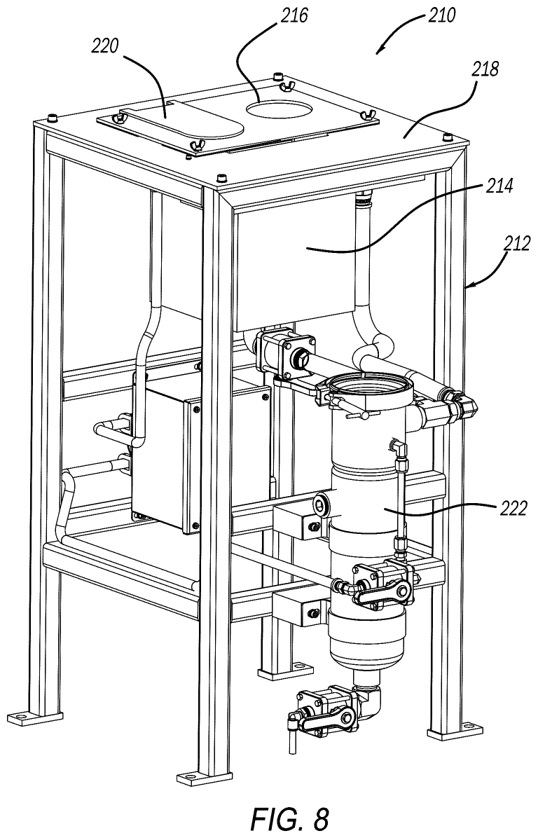

Eventually a hard film will develop on the skives 114, 116 and 118 that can't be cleaned by the skive cleaner 180, but needs to be removed. FIG. 8 is an isometric view of a skive solvent wash cleaner 210 that is used to clean this film off of the skives 114, 116 and 118. The wash cleaner 210 includes a frame 212 that supports a tank 214 holding a cleaning solvent and strategically positioned brushes (not shown) and having a top opening 216 extending through a top plate 218 on the frame 212, where a cover 220 is slidable mounted to the plate 218 to cover the opening 216 when the cleaner 210 is not being used and to uncover the opening 216 when the cleaner 210 is being used. A pump and circulation system 222 provides solvent to and removes solvent from the tank 214. After the skives 114, 116 and 118 have been cleaned by the skive cleaner 180 as described above, the robot arm 102 moves the skive assembly 112 to the wash cleaner 210, extends all of the skives 114, 116 and 118 and moves the skive assembly 112 through the opening 216 and into the tank 214 to wash off the film on the skives 114, 116 and 118. The robot arm 102 rotates and oscillates the skive assembly 112 up and down while it is in the tank 214 to rub the skives 114, 116 and 118 against the brushes to help remove the film. The skive assembly 112 is then removed from the tank 214 and the skives 114, 116 and 118 are retracted. In an alternate embodiment, the brushes can move and the skives 114, 116 and 118 can be stationary.

The solvent cleaner 210 can also have a number of features. For example, the brushes can be configured to clean the front and the back of the skives at the same time, and can be configured to be removed and replaced without the use of tools. The tank 214 can have a fluid level sensor to indicate the level of the solvent therein, and can have a simple drain and replacement feature. The solvent cleaner 210 can have a closed design to minimize vapors and solvent evaporation and a closed recirculating system to maintain the solvent level. The opening 216 can be covered with a lid that automatically opens and closes. A filter reservoir can be provided to clean and maintain the solvent level.

A cleaner can also be provided to clean the applicator 72 including the nozzles 82, 84 and 86. This cleaner could have an air nozzle for sealant blow off, a design that manages airflow to eliminate overspray on vision equipment and an independent air nozzle control to optimize cleaning.

The various sealant dispensing and skiving devices and systems discussed herein can offer a number of advantages and features many of which are discussed above. For example, as discussed above, the bead size of the dispensed sealant can be measured by a vision system to adjust the dispensing pressure to dynamically adjust the bead size. Further, component gap sizes can be measured, robot speeds can be changed and/or dispense parameters can be adjusted to increase or decrease the sealant bead size. The sealant dispensing nozzles can be accurately positioned and the amount of the sealant being dispensed can be minimized to reduce the sealant waste volume, where too much sealant results in high waste, sealing defects and the need to provide additional skiving. Vision systems can be employed to locate each seam being sealed independently to adjust for sheet metal body build variations. The skives can be keyed to facilitate the accurate location of each skive. The skive assembly provides the ability to accurately install replacement skives. A position sensor can be employed to identify the extend/retract position of the skive and a vision system can be employed to provide seam offsets for accurate placement of the skive.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. An assembly system for applying a sealant to seams on a part, said part including gauge reference holes, said system comprising:
a first assembly station including at least one station vision sensor and at least one robot having a robot vision sensor and a dispense applicator, said dispense applicator being configured to apply the sealant to the seams, said at least one station vision sensor at the first assembly station providing images of the gauge reference holes on the part, and said robot vision sensor on the at least one robot at the first assembly station providing images of the seams on the part;
a second assembly station positioned downstream from the first assembly station and including at least one station vision sensor and at least one robot having a robot vision sensor and a skive, said skive being configured to remove excess sealant from the seams on the part, and said at least one station vision sensor at the second assembly station providing images of the gauge reference holes on the part; and
a control system responsive to signals from the station vision sensors and the robot vision sensors, said control system using the signals from the station vision sensors at both the first assembly station and the second assembly station to identify the orientation and location of the part in space and using the signals from the robot vision sensors on the at least one robot at the first assembly station to provide an offset of the seams relative to the gauge reference holes on the part, said control system providing the offsets from the first assembly station to the second assembly station so that the second assembly station knows the location of the seams relative the gauge reference holes determined at the first assembly station.

2. The assembly system according to claim 1 wherein the control system uses the signals from the robot vision sensor on the at least one robot at the first assembly station to measure a size of the sealant that has been dispensed by the dispense applicator, said control system controlling a dispensing pressure of the dispense applicator so as to maintain a certain size of the sealant.

3. The assembly system according to claim 2 wherein the control system uses the signals from the robot vision sensor on the at least one robot at the first assembly station to measure the size of the sealant at multiple points on the seam to provide individual seam width data.

4. The assembly system according to claim 2 wherein the certain size of the sealant is a sealant bead width in the range of 3 mm to 12 mm.

5. The assembly system according to claim 1 wherein the first assembly station also includes a skive configured to remove excess sealant from the seams on the part and the second assembly station also includes a dispense applicator configured to apply the sealant to the seams.

6. The assembly system according to claim 1 wherein the part is a vehicle.

7. The assembly system according to claim 1 wherein the at least one station vision sensor at the first assembly station is a first and second vision sensor positioned at one side of the part and a third and fourth vision sensor positioned at an opposite side of the part, and wherein the at least one station vision sensor at the second assembly station is a fifth and sixth vision sensor positioned at the one side of the part and a seventh and eighth vision sensor positioned at the opposite side of the part.

8. The assembly system according to claim 1 wherein the at least one robot at the first assembly station is first and second robots slidably positioned on a rail at one side of the part and third and fourth robots slidably positioned on a rail at an opposite side of the part, and wherein the at least one robot at the second assembly station is fifth and sixth robots slidably positioned on a rail at the one side of the part and seventh and eighth robots slidably positioned on a rail at the opposite side of the part.

9. An assembly system for applying a sealant to seams on a part, said part including gauge reference holes, said system comprising:
an assembly station including at least one station vision sensor and at least one robot having a robot vision sensor and a dispense applicator, said dispense applicator being configured to apply a sealant to the seams on the part, said at least one station vision sensor providing images of the gauge reference holes on the part, and said robot vision sensor on the at least one robot providing images of the seams on the part; and
a control system responsive to signals from the robot vision sensor on the at least one robot and the at least one station vision sensor, said control system using the signals from the at least one station vision sensor to identify the orientation and location of the part in space and using the signals from the robot vision sensor on the at least one robot to provide an offset of the seams relative to the gauge reference holes on the part, said control system using the signals from the robot vision sensor on the at least one robot to measure a size of the sealant that has been dispensed by the dispense applicator, said control system controlling a dispensing pressure of the dispense applicator so as to maintain a certain size of the sealant.

10. The assembly system according to claim 9 wherein the control system uses the signals from the robot vision sensor on the at least one robot to measure the size of the sealant at multiple points on the seam to provide individual seam data.

11. The assembly system according to claim 9 wherein the certain size of the sealant is a sealant bead width in the range of 3 mm to 12 mm.

12. The assembly system according to claim 9 wherein the assembly station also includes a skive configured to remove excess sealant from the seams on the part.

13. The assembly system according to claim 9 wherein the part is a vehicle.

14. The assembly system according to claim 9 wherein the at least one station vision sensor is a first and second vision sensor positioned at one side of the part and a third and fourth vision sensor positioned at an opposite side of the part.

15. The assembly system according to claim 9 wherein the at least one robot is first and second robots slidably positioned on a rail at one side of the part and third and fourth robots slidably positioned on a rail at an opposite side of the part.

16. A vehicle assembly system for applying a sealant to seams on a vehicle, said vehicle including gauge reference holes, said system comprising:
a first assembly station including a plurality of station vision sensors and a plurality of robots each having a robot vision sensor and a dispense applicator, said dispense applicator being configured to apply the sealant to the seams, said plurality of station vision sensors at the first assembly station providing images of the gauge reference holes on the vehicle, and said robot vision sensor on the plurality of robots at the first assembly station providing images of the seams on the vehicle;
a second assembly station positioned downstream from the first assembly station and including a plurality of station vision sensors and a plurality of robots each having a robot vision sensor and a skive, said skive being configured to remove excess sealant from the seams on the vehicle, and said plurality of station vision sensors at the second assembly station providing images of the gauge reference holes on the vehicle; and
a control system responsive to signals from the robot vision sensors and the station vision sensors, said control system using the signals from the station vision sensors at both the first assembly station and the second assembly station to identify the orientation and location of the vehicle in space and using the signals from the robot vision sensor on the plurality of robots at the first assembly station to provide an offset of the seams relative to the gauge reference holes on the vehicle, said control system providing the offsets from the first assembly station to the second assembly station so that the second assembly station knows the location of the seams relative the gauge reference holes determined at the first assembly station, said control system also using the signals from the robot vision sensor on the plurality of robots at the first assembly station to measure a size of the sealant that has been dispensed by the dispense applicator, said control system controlling a dispensing pressure of the dispense applicator so as to maintain a certain size of the sealant.

17. The assembly system according to claim 16 wherein the first assembly station also includes a skive configured to remove excess sealant from the seams on the vehicle and the second assembly station also includes a dispense applicator configured to apply the sealant to the seams.

18. The assembly system according to claim 16 wherein the certain size of the sealant is a sealant bead width in the range of 3 mm to 12 mm.

19. The assembly system according to claim 16 wherein the plurality of station vision sensors at the first assembly station is a first and second vision sensor positioned at one side of the vehicle and a third and fourth vision sensor positioned at an opposite side of the vehicle, and wherein the plurality of station vision sensors at the second assembly station is a fifth and sixth vision sensor positioned at the one side of the vehicle and a seventh and eighth vision sensor positioned at the opposite side of the vehicle.

20. The assembly system according to claim 16 wherein the plurality of robots at the first assembly station is first and second robots slidably positioned on a rail at one side of the vehicle and third and fourth robots slidably positioned on a rail at an opposite side of the vehicle, and wherein the plurality of robots at the second assembly station is fifth and sixth robots slidably positioned on a rail at the one side of the vehicle and seventh and eighth robots slidable positioned on a rail at the opposite side of the vehicle.
